(19) United States
(12) Patent Application Publication
(10) Pub. No.: US 2023/0256518 A1
(43) Pub. Date: Aug. 17, 2023

(54) METHOD FOR DISPENSING POWDER FROM AN INTERMEDIATE RESERVOIR OF A POWDER-BED FUSION APPARATUS AND A CORRESPONDING APPARATUS

(71) Applicant: SLM Solutions Group AG, Lubeck (DE)

(72) Inventor: Karsten Hübinger, Ponitz (DE)

(73) Assignee: SLM Solutions Group AG, Lubeck (DE)

(21) Appl. No.: 18/136,128

(22) Filed: Apr. 18, 2023

Related U.S. Application Data
(63) Continuation of application No. PCT/EP2021/079377, filed on Oct. 22, 2021.

(30) Foreign Application Priority Data
Oct. 30, 2020 (DE) 10 2020 128 598.1

(51) Int. Cl. B22F 12/50; B22F 10/28; B22F 12/00; B33Y 30/00; B33Y 10/00

(52) U.S. Cl. CPC B22F 12/50; B22F 10/28; B22F 12/22; B33Y 10/00; B33Y 30/00

(57) ABSTRACT

A dosing feeder for a powder-fusing apparatus that includes a powder inlet that is configured to receive powder from a discharge opening of a powder bunker, a powder outlet that is configured to release powder to a recoater reservoir of the powder fusion apparatus, and a powder support that is located in between the powder inlet and the powder outlet and that is configured to convey powder from the powder inlet to the powder outlet. The dosing feeder enables dosing of the powder transferred from the powder bunker to the recoater reservoir with high precision if the powder support is coupled to an ultrasonic transmitter and/or to a vibrational drive.

### 1. FIELD OF THE INVENTION

The invention relates to additive manufacturing, as well commonly referred to as 3D-printing. More precisely, the invention provides an improvement of the powder-bed fusion process, a corresponding powder dispenser and a powder-bed fusing apparatus with the dispenser.

### 2. DESCRIPTION OF RELATED ART

Additive manufacturing is a growingly important and capable method of manufacturing 3D workpieces. There are different variants of additive manufacturing, but herein we focus on methods and an apparatus for joining powder particles by selectively heating particles, e.g., on top of a bed of powder particles to adhere some of the particles to each other. The powder particles are adhered by sintering, fusing and/or welded to each other. The heat for these processes is typically provided by preferably focused radiation, for example by an electron beam or by a laser beam, selectively heating portions of the top layer of the powder bed, thereby attaching particles of the top layer to particles of a preceding layer and to neighbored particles in the top layer. This process is generally referred to as powder-bed fusion or simply powder fusion. Herein, we will not distinguish between different types of radiation and will simply refer to “beam” or “beams”.

Modern apparatus for powder-bed fusion have a housing with a process chamber. The process chamber includes a support-opening for accommodating a movably supported workpiece support. Initially, a thin layer of powder is applied to the workpiece support. This is mostly accomplished by a recoater. The recoater is a vehicle, being driven forth and back over the opening in the bottom, thereby coating the workpiece support with a layer of powder. Recoaters have been described in a number of publications, e.g., in WO 2018/156264 A1, WO 2017/143145A1, EP 1 234 625 A and DE102006056422B3, to name only a few. These recoaters can be distinguished very roughly in two groups or types:
(i) powder is supplied to the bottom of the process chamber, e.g. by an opening next to the support opening and subsequently distributed by a distributor. This distributor, herein being considered as a “type (i) recoater” typically has at least one of a blade, a roller, a lip or a similar means configured for traveling over the support opening to thereby form a layer of fresh powder over the workpiece support.
(ii) a powder reservoir is movably supported to travel over the support opening thereby applying a layer of fresh powder on the workpiece support (“type (ii) recoater”). Often, the type (ii) recoaters as well comprise one or more distributors for planing, or in other words for grading, the powder layer. We refer herein to the reservoir of the recoater as the “recoater reservoir” as well as the “recoater’s reservoir”.

Once a fresh layer of powder has been applied, at least one beam is moved over the top layer of the coated surface, thereby adhering some powder grains to each other and in some cases as well to the workpiece support. The workpiece support is subsequently lowered and the recoater applies the next layer of powder. The next layer is as well subjected to the beam for selectively adhering powder grains to each other and the structure of previously adhered grains. The process of lowering the workpiece support, applying a new layer of powder and laser “writing” is iterated to thereby obtain a 3D object. This process has been described by a number of publications, e.g. in US 2017/0001243 A1, US 9,061,465B2, to name only two.

DE 10 2004 022 387 A1 discloses a recoater of a powder-bed fusion apparatus with circular blade for distributing the powder. The circular blade encloses and in this sense comprises a grid of linearly extending blades. A new layer of powder is applied by pushing the powder over the support opening using the circular blade. As taught by DE 10 2004 022 387 A1, the circular blade shears particle agglomerates, which is reported to provide denser powder layers with a reduced roughness. To further improve density of the powder layer, it is suggested to couple the circular blade to an ultrasound producing means.

DE 101 17 875 C1 suggests to apply a new layer in the powder-bed fusion process by using a type (ii) recoater having blade for providing a thin homogenous powder layer. The blade is rotatably supported and driven to execute a rotational vibration. In operation, powder is delivered from a powder bunker to a recoater reservoir. From the recoater reservoir the powder is deposited in front of the rotationally vibrating blade and pushed over the existing powder bed using the rotationally vibrating drive. This rotational vibration is considered to break up particle agglomerations in the powder and to homogenize the powder while applying the thin powder layer.

Regardless, whether a recoater is a type (i) or type (ii) recoater, the powder is dispensed from an intermediate reservoir (as well referred to as bunker) either to the bottom of the process chamber (in case a type (i) recoater is used) or into the reservoir of a type (ii) recoater. In presently used powder-bed fusing apparatuses dispensing of the powder from the intermediate reservoir to the recoater’s reservoir is obtained by a rotary feeder. (Please considered this to include the case of dispensing onto the bottom of the process chamber. The location onto which the powder is dispensed from the bunker can be considered to form the recoater’s reservoir of type (i) recoaters).

The rotary feeder has an elongated “feed wheel”, which can be considered as a feed shaft. The feed shaft extends over the width of the support opening. The feed shaft has one or more notches extending along the rotational axis of the feed shaft. When a notch faces upwards into a down facing discharge opening of the intermediate reservoir, powder slides into the volume of the notch. Rotation of the shaft turns the notch to face downwards, thereby depleting the notch, i.e. powder pours from the notch into the recoater’s reservoir. In other words, each revolution of the notch is expected to convey a predefined amount of powder into the recoater’s reservoir.

### SUMMARY

The invention is based on the observation that the notches of feed shafts of present powder-bed fusing apparatuses have to be manufactured by milling and grinding, being costly. Further, the feed shafts are difficult to seal as required to reduce inert gas leakage out of the process chamber and powder particle fall through. In addition, dosing the amount of powder being dispensed can be adjusted only in integer multiples of the notches’ volumes and is further compromised by powder bridges forming over portions of the intermediate reservoir’s discharge outlet. Based on these observations, the object underlying the invention is to improve loading of a recoater’s reservoir of a powder-bed fusing apparatus.

For example, the above sketched problems can be solved by a dosing feeder for a powder-fusing apparatus. The dosing feeder may comprise a powder inlet. Via the powder inlet, the dosing feeder may receive powder from a discharge opening of a powder bunker. In practice, these powder bunkers are positioned either inside the process chamber or at least include a discharge opening connecting the bunker’s storage volume via the discharge opening with the process chamber. Connecting in this context means to enable a transfer of powder from the bunker into the process chamber. The bunker is an intermediate powder reservoir of a powder-supply system. Herein, we use the terms bunker or powder bunker only to linguistically distinguish between the recoater’s reservoir and the intermediate reservoir (= the bunker). In other words, the terms powder bunker and bunker could be replaced by intermediate powder reservoir without changing the technical teaching of the application and the patent granted on the application.

Summarizing, the dosing feeder is configured to receive powder from the bunker. For example, the dosing feeder’s powder inlet may be positioned right below the bunker’s discharge opening, thereby enabling feeding the dosing feeder’s powder inlet by powder falling down form the bunker’s discharge opening.

The dosing feeder includes a powder outlet, being configured to release powder to a recoater reservoir of the powder fusion apparatus. The recoater reservoir may be a container of a type (ii) recoater or simply a place on a base plate (i.e. on the bottom) of the process chamber from which the powder is distributed by a type (i) recoater.

In between of the dosing feeder’s powder inlet and the dosing feeder’s powder outlet is a powder support. The powder support is configured to receive powder via the powder inlet and is further configured to convey the powder to the powder outlet. The powder support, as the word indicates, supports the powder, i.e. it maintains the powder on the powder support in position, until it is conveyed by conveying means towards the powder outlet. In an example, the powder support can be plate or board being positioned below the powder inlet.

Preferably, there is a gap between the powder inlet and the powder support. The gap defines the maximum height of powder being accumulated on the plate. The gap is thus preferably bigger than the grain size the dosing feeder is rated for. Preferably the height of the plate and/or the height of the powder inlet is adjustable to thereby enable adjusting the gap height. For example, at least one of the powder support and the powder inlet may be releasably attached to a dosing feeder support structure having a vertical extension and/or an adjustable vertical extension, thereby enabling to adjust the gap.

The powder support may be sloped towards the powder outlet. But preferably the slope is below the critical slope being defined as the slope at which the static friction force and the down slope force have the same absolute value. Increasing the slope above the critical slope thus would cause the powder to slide over the powder support. In other words, increasing the slope of the powder support above the critical slope would transform the powder support into a chute.

In another example, the powder support comprises a grate, i.e. a sieve. We use the term grate only to linguistically distinguish over another optional sieve being explained below. Hence, instead of “grate” one could use herein the term “first sieve”. The mesh size of the grate is greater than the powder grains being specified to be dosed by the dosing feeder. Preferably, the mesh size of the grate is at least two times greater than the powder grains, particularly preferred, the mesh size of the grate is at least three times greater than the powder grains. Further, the mesh size is smaller than the critical mesh size being defined to be the mesh size above which the powder falls through a static grate.

In a preferred example, the dosing feeder’s powder support is coupled to an ultrasonic transmitter and/or to a vibrational drive (herein jointly referred to as “drive”, for short). The ultrasound and/or the vibrations, respectively, reduce the critical slope as well as the angle of repose of the powder on the powder support. Thus, in case the powder support is a board or plate the powder slides towards the powder outlet. Only to avoid misinterpretations, “coupled” in this context describes a mechanical connection enabling a propagation of ultrasound waves being generated by the ultrasonic transmitter in the powder support, e.g. in the grate. In case of a vibrational drive “coupled” describes a mechanical connection between the vibrational drive and the powder support (e.g. a grate) that transmits vibration of the vibrational drive to the powder support. A vibration is considered as a movement of the grate, be it ‘forth and back’ or ‘p and down’ or a combination thereof. The vibrational drive may cause the powder support to oscillate as such, e.g. between two positions and/or orientations, but as well (and/or) to excite at least one normal mode of the powder support. All of these vibrations provide a reduction of the critical slope angle and/or a reduction of the critical angle of repose. A portion of the powder thus flows to the recoater reservoir. In case of an excitation by ultrasound, the ultrasound waves propagating through the powder support as well reduce the critical slope angle as well as the critical angle of repose. Further, the ultrasound may as well may propagate through the powder and thereby so to speak ‘fluidize’ the bulk material, as well causing a powder flow to the recoater reservoir. As usual, herein an ultrasonic transmitter is an ultrasound generator, as well referred to as transmitting ultrasonic transducer.

By the energy of the vibrational and/or ultrasonic excitation, the fluidization can be gradually controlled, i.e. the volume of powder per unit of time being conveyed to the outlet can be adjusted by increasing or decreasing the excitation. For a given excitation of the powder support, the conveying rate is constant, hence the amount of powder to be dispensed to or into the recoater reservoir can be adjusted by selecting the duration of the excitation. In practice, the operation of the drive is preferably controlled by a controller.

As already indicated above, the powder support preferably comprises a grate, wherein the grate is coupled to an ultrasonic transmitter and/or to a vibrational drive, thereby being configured to enable a powder flow through the grate by exiting the grate by operation of the ultrasonic transmitter and/or the vibrational drive.

Preferably, the powder support comprises a frame, wherein the grate is supported by the frame and preferably mechanically attached to the frame. This measure provides for a stable grate and enables to reliably couple an ultrasonic transmitter as well as a vibrational drive via the frame to the grate. The frame further simplifies sealing of the powder support against a housing of the dosing feeder.

A connecting element may connect, i.e. mechanically attach the grate via the frame to the ultrasonic transmitter and/or to the vibrational drive.

For example, the dosing feeder may comprise a feeder housing with a powder channel. The powder channel is defined by a channel wall of the housing. The powder channel may connect the powder inlet and the powder outlet. Preferably, the grate is positioned transverse to a longitudinal extension of the powder channel, thereby separating the channel into an inlet facing upper channel portion and an outlet facing lower channel portion. The longitudinal extension of the powder channel can be considered to be defined by the longitudinal channel axis in case of a straight channel. In case of a curved channel, the neutral axis of a bent beam assumed to be sitting in the channel may be considered to define the direction the longitudinal extension of any infinitesimal channel section. Transverse means that the grate intersects the powder channel in an angle, preferably but not necessarily in a right angle (±15°, preferably ±10°, even more preferred ±5° or less). The angle may preferably be between 60° and 120°.

The housing may support the powder support. For example, the channel wall may form a recess, into which the powder support sealingly engages. This enables a simple assembly while at the same time bypass powder can be avoided. Likewise, the powder support may comprise a recess into which a protrusion of the channel wall sealingly engages.

Particularly preferred, an elastic member is positioned between the powder support and the housing. This enables to prevent a direct transmission of vibrations from the powder support to the housing while sealing the gap between the powder support and the housing. The other components of the powder-bed fusion apparatus are thus less stressed by the ultrasound and/or the vibrations, increasing their longevity as well as accuracy of operation. Thus, the quality of the workpiece can be improved.

As already apparent, the dosing feeder may be installed in a powder-bed fusing apparatus, as well referred to as “powder-fusing apparatus”. The powder-fusing apparatus, may at least comprise a process chamber, a powder bunker with a powder release opening, wherein the discharge opening is in fluid communication with the process chamber. A recoater reservoir may be positioned in the process chamber. The dosing feeder’s powder inlet is preferably positioned below the discharge opening of the powder bunker. Thereby, powder flow out of the discharge opening is stopped, once the dosing feeder’s powder inlet is filled with powder. Powder being conveyed to the recoater reservoir is immediately replenished by gravity. The dosing feeder’s powder outlet is preferably positioned above a parking position of the recoater. In this case, the dosing feeder’s powder outlet can directly feed the recoater reservoir, in case the recoater is parked in its parking position. As usual, the recoater may be positioned between the coating cycles on a parking spot, the so called parking position. In between of these coating cycles the recoater reservoir can thus be refilled from the dosing feeder’s powder outlet.

Preferably, the powder bunker includes a powder inlet opening. As usual the powder inlet opening may be connected to a powder distribution system for conveying powder via the bunker’s powder inlet opening into the bunker. The powder may e.g. be provided e.g. by a powder supply line from a main tank and/or excess powder removal traps of the process chamber. From these powder sources the bunker is provided with fresh powder by a powder conveying system. For example, a pneumatic conveying system may be used, wherein the conveying gas flow is preferably an inert gas flow. In a particularly preferred example, the powder inlet opening is protected by a sieve (to be distinguished from the first sieve, i.e. the grate) for separating particles above a predefined dimension. Thus, the (second) sieve has a (second) sieve mesh size separating particles above the sieve mesh size. These particles hence cannot be transported with the powder into the bunker.

As already apparent, the grate has a grate mesh size and preferably the grate mesh size is greater than the sieve mesh size, thereby avoiding the accumulation of particles to be rejected in the process chamber. This measure ensures a particular high dosing precision, mainly because the free area of the grate is not reduced over time by particles clogging the grate. This enhances the quality of the manufactured workpiece. The grate and the sieve could be combined into a single grate. In particular in this case, the dosing feeder may comprise a grate residue removal slider. The a grate residue removal slider may be configured to scrape residues from the grate of the grate into a residue reservoir. For example, the grate residue removal slider may be movably supported by at least one guide rail and/or a telescopic arm positioned upstream and/or besides the grate. Preferably, the grate residue removal slider is coupled to a drive for advancing the grate residue removal slider from a first position over the upstream facing grate surface to a second position and as well for retracting the a grate residue removal slider back into its first position.

The method for filling a reservoir of a recoater of a powder-fusing apparatus, may at least comprise the steps of discharging powder from a powder bunker onto a powder support of a dosing feeder, e.g., of a dosing feeder as explained above. Further the method may comprise exciting phonons in the powder support of the dosing feeder and/or exciting the powder support to oscillate relative to a process chamber boundary and to excite normal modes of the powder support. Each of these measures enables to convey powder via an outlet of the dosing feeder to the recoater reservoir in a controlled manner.

### BRIEF DESCRIPTION OF THE DRAWINGS

In the following, the invention will be described by way of example, without limitation of the general inventive concept, on examples of embodiment and with reference to the drawings.

FIG. 1 shows a first example of a powder-bed fusing apparatus.

FIG. 2 shows a second example of a powder-bed fusing apparatus.

FIG. 3 shows an example of dosing feeder in a longitudinal sectional view.

FIG. 4 shows the dosing feeder of FIG. 4 in a cross-sectional view perpendicular to the view in FIG. 3.

Generally, the drawings are not to scale. Like elements and components are referred to by like labels and numerals. For the simplicity of illustrations, not all elements and components depicted and labeled in one drawing are necessarily labels in another drawing even if these elements and components appear in such other drawing.

While various modifications and alternative forms, of implementation of the idea of the invention are within the scope of the invention, specific embodiments thereof are shown by way of example in the drawings and are described below in detail. It should be understood, however, that the drawings and related detailed description are not intended to limit the implementation of the idea of the invention to the particular form disclosed in this application, but on the contrary, the intention is to cover all modifications, equivalents and alternatives falling within the spirit and scope of the present invention as defined by the appended claims.

### DETAILED DESCRIPTION

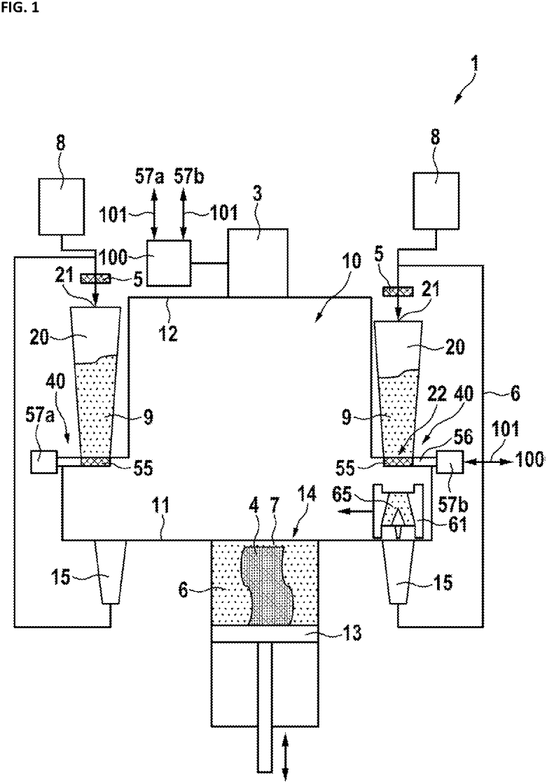

The powder-bed fusing apparatus 1 in FIG. 1 includes a process chamber 10 being defined by a process chamber housing wall 12. In operation the process chamber 10 is preferably filled with an inert gas. In a preferred example, a flow of the inert gas enters the process chamber 10 via at least a first opening in the process chamber housing wall 12 and leaves it via at least one other opening.

The process chamber 10 includes a base plate 11 being considered as bottom 11 of the process chamber 10. The support opening 14 accommodates a movably supported workpiece support 13, supporting a workpiece 4. For manufacturing the workpiece 4 powder 9 of a powder bed 6 on top of the workpiece support 4 is fused by a beam being generated by a beam emitting unit 3. The beam emitting unit 3 comprises a beam deflector or a beam directing means, configured to deflect or direct the generated beam onto the powder bed 6.

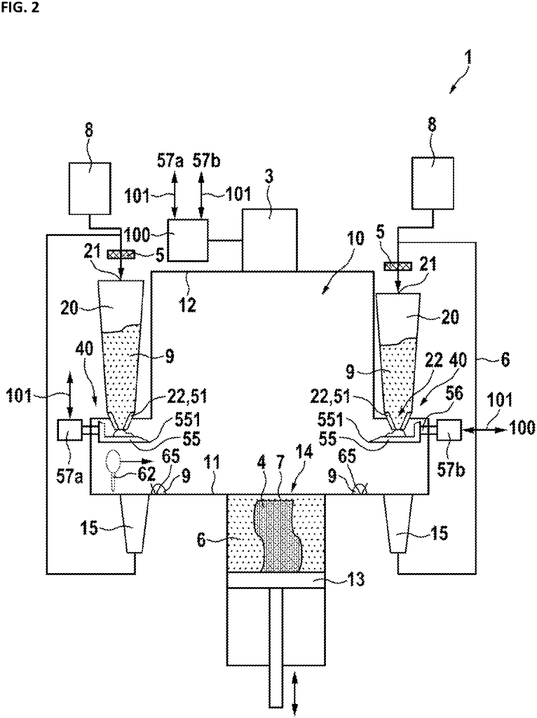

To enable fusing successive layers 7 of powder 9 a new layer 7 of powder 9 is added on top of the powder bed 6 by a recoater 61 (or 62 see FIG. 2) each fusing step. Subsequently, a portion of the powder grains in the newly applied top layer 7 is attached to the workpiece 4 being covered by the top layer 7 by selectively heating the powder grains using the beam generating unit 3. After the grains of the topmost layer 7 have been attached to and thereby integrated into the workpiece 4 the workpiece support 13 is lowered and the recoater 61 travels over the support opening 14 to thereby apply a new layer 7 of powder 9.

As depicted in FIG. 1, the recoater 61 includes a recoater reservoir 65. Every time the recoater 61 applies a new layer 7 of powder to the powder bed, the powder level in the recoater reservoir is reduced, as at least a portion of the powder 9 being stored in the recoater reservoir 65 is added to the powder bed 6 by the recoater 61. Once the powder level in the recoater reservoir 65 is below a given level and/or after each recoating step the recoater reservoir 65 may be (re)filled. To this end, the recoater reservoir 65 is positioned below a discharge opening 22 of an intermediate reservoir 20, herein referred to as powder bunker 20 or briefly bunker 20 as explained above.

A dosing feeder 40 is positioned between the bunker’s 20 discharge opening 22 and the recoater reservoir 65. Hence, the dosing feeder 40 is configured to control the amount of powder being transferred from the bunker 20 to the recoater reservoir 65. The dosing feeder 40 is connected by at least one control line 101 to a controller 100 of the powder-bed fusing apparatus. Hence the controller may be configured to control the amount of powder being conveyed by the dosing feeder 40 to the recoater reservoir 65. In the depicted example, a drive 57 of the dosing feeder 40 is connected via the at least one control line 101 to the controller 100.

Preferably, the powder-bed fusing apparatus further includes or is connected to at least one main powder tank 8, being connected via powder lines of a powder distribution system 6 to a powder inlet 21 of a bunker(s) 20 as shown in FIG. 1 and FIG. 2. A (second) sieve is positioned upstream the bunker’s powder inlet 21.

The main powder tank 8 may be firmly connected to or separate from the housing enclosing the process chamber 10, the bunker 20 and the beam generating unit 3. Also, different bunkers 20 enclosed by different housings may be connected collectively at least one main powder tank 8. Generalizing, at least one a main powder tank 8 is connected to at least one of multiple different powder-bed fusing apparatuses and configured to feed the(ir) respective bunker(s) via a powder-supply line.

In FIG. 1 and FIG. 2, the main tanks 8 are depicted to be smaller than the bunkers 20, however, in practice the opposite is preferred.

Excess powder is collected in optional excess powder traps 15 in the bottom plate 11 and may be conveyed by the powder distribution system 6 via the optional (sieves) upstream the powder inlets 21 into the bunker 20.

It should be noted that FIG. 1 shows two bunkers and two dosing feeders. In other examples only a single bunker 20 and a single dosing feeder 40 may be employed. In this sense, the powder-bed fusing apparatus comprises at least one (1) bunker 20. In yet other examples, the bunker 20 can be omitted. In these examples the dosing feed may receive the powder to be dosed directly from the tank 8, e.g., via the optional (second) sieve upstream the dosing feeder. For example, the powder-bed fusing apparatus may comprise multiple bunkers 20 and/or dosing feeders 40, wherein different bunkers 20 and/or dosing feeders 40 may be configured to feed different powders (the powders may vary in grain size and/or material composition) to a recoater.

FIG. 2 shows another powder-bed fusing apparatus 1, being very similar to the powder-bed fusing apparatus 1 in FIG. 1 and the description of FIG. 1 can be read on FIG. 2 as well, except for the recoater: In FIG. 2, the recoater 62 fails to have a movable reservoir like recoater 61 in FIG. 1. The recoater 62 in FIG. 2 includes a distribution means, e.g. a blade, being movably supported to travel forth and back over the support opening 14 to thereby distribute an amount of powder 9 being deposited on top of the process chamber’s 10 base plate 11, defining the bottom of the process chamber 10. The location where the powder embankment has been deposited is thus a powder reservoir 65. This powder embankment may be pushed over the support opening 14 by the recoater 62 to thereby apply a new powder layer 7 to the powder bed 6. In this sense, the location on the base plate 11 supporting the powder 9 embankment can be considered as a recoater reservoir 65. As explained with respect to FIG. 1, a dosing feeder is positioned below the bunker’s 20 discharge opening 22. Thereby, powder 9 in the bunker 20 flows onto the powder support plate 55 until the accumulates powder 9 embankment on the support plate 55 blocks the discharge opening 22. Thus, the discharge opening 22 can be considered to define the dosing feeder’s 40 powder inlet 51.

As depicted in FIG. 2, in an embodiment, the powder support plate 55 is connected to a drive 57 (shown as 57a and 57b). The drive 57 is preferably an ultrasonic transmitter, being coupled to at least one support plate 55 to thereby couple ultrasound waves into the powder support plate 55. Alternatively, the drive may reciprocate the powder support plate or excite other kind of vibrations of the powder support plate 55. The ultrasound and/or the vibrations at least partially fluidize the powder embankment on the powder support plate, and the powder thus flows over the process chamber 10 facing edge 551 of the powder support plate 55 onto the location 65 (the recoater reservoir 65) on the base plate 11. The edge 551 can thus be considered as a powder outlet of the dosing feeder 40 in FIG. 2.

In an Embodiment, the amount of powder 9 being dosed onto the location 65 is controlled by the controller 100, e.g. by the time the respective drive 47 is operated, assuming the amplitude and frequency of the excitation to be constant, but of course, in another embodiment, the controller is as well configured to control the frequency and/or the amplitude of the excitation.

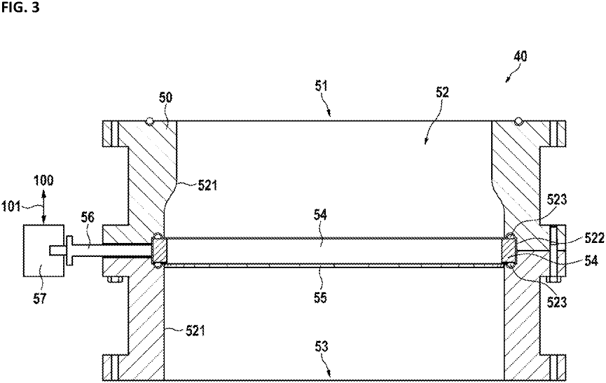

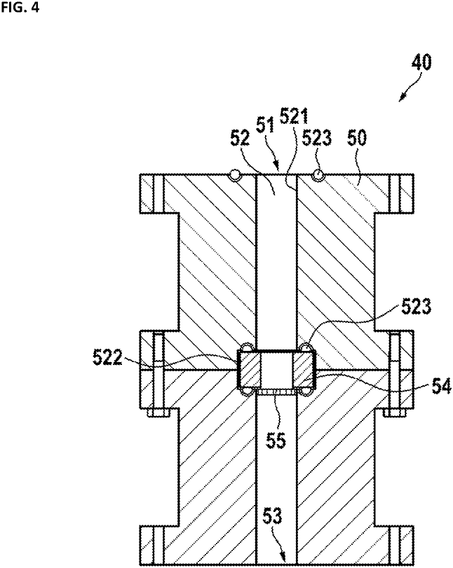

Another preferred example of a dosing feeder is depicted in FIG. 3 and FIG. 4: The dosing feeder 40 may replace the dosing feeders 40 in FIG. 1 and/or FIG. 2.

As shown in FIG. 3 and FIG. 4, the dosing feeder 40 includes a housing 50 with a channel 52 being delimited by a channel wall 521. The channel wall 521 includes at least a first opening 51, the powder inlet 51 and second opening 53, the powder outlet 53. In other words, the channel 52 provides a fluid communication from the powder inlet 51 to the powder outlet 53 (if the channel is not filled with powder).

The channel 52 includes a recess 522. A frame 54 of a powder support engages into the recess 544 to thereby maintain the powder support in a position in which it traverses the channel 52. The powder support thus separates the channel 52 in an upper and an lower portion, wherein the powder inlet faces upwards to the bunker’s 20 discharge opening (if mounted as intended) and the powder outlet 53 downwards to the reservoir. In a preferred embodiment the powder inlet is attached to the powder discharge opening 22 (see FIG. 1).

In an example, the frame 54 engages preferably peripherally into the recess 522 and the gap between the frame 54 and the channel wall 521 is preferably sealed, e.g., by at least one gasket 523. The frame 54 supports a powder support grate 55 being a sieve. The mesh size of the sieve is preferably bigger than the specified median grain size of the powder 9, but smaller than the critical mesh size. Hence, as long as the powder support grate 55 is not excited by a drive 47, being an ultrasonic transmitter and/or a vibrational drive, the powder 9 falling down through the bunker’s discharge opening 22 into the channel 52 accumulates on the grate, with only negligible powder fall through. Operating the drive 47, however, releases a powder flow through the grate 55 and the lower portion of the channel 52 into (or onto) the recoater reservoir 65. Similar to the examples in FIG. 1 and FIG. 2, the drive 47 is controlled by a controller 100 via a control line 101.

It will be appreciated by those skilled in the art having the benefit of this disclosure that this invention is believed to provide dosing feeder for a powder-fusing apparatus, a powder-fusing apparatus and a method for filling a recoater, e.g., of a powder-fusing apparatus. Further modifications and alternative embodiments of various aspects of the invention will be apparent to those skilled in the art in view of this description. Accordingly, this description is to be construed as illustrative only and is provided for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

LIST OF REFERENCE NUMERALS

| | |
|---|---|
| 1 | powder-bed fusing apparatus |
| 3 | beam emitting unit |
| 5 | workpiece |
| 6 | powder bed |
| 7 | powder layer |
| 8 | main powder tank |
| 9 | powder |
| 10 | process chamber |
| 11 | base plate / bottom |
| 12 | process chamber housing wall |
| 13 | workpiece support |
| 14 | support opening |
| 15 | excess powder trap |
| 16 | powder conveying system |
| 20 | Bunker/ intermediate reservoir |
| 21 | powder inlet of bunker |
| 22 | discharge opening of bunker |
| 40 | dosing feeder |
| 50 | housing of dosing feeder |
| 51 | powder inlet of dosing feeder |
| 52 | channel of dosing feeder |
| 521 | channel wall |
| 522 | recess in channel wall |
| 523 | gasket |
| 53 | powder outlet of dosing feeder |
| 54 | frame |
| 55 | powder support grate /powder support plate |
| 551 | edge of powder support plate 55 |
| 56 | connecting element |
| 57a, 57b | vibrational drive / ultrasonic transmitter |
| 61 | recoater (type (i)) |
| 62 | recoater (type (ii)) |
| 65 | recoater reservoir |
| 100 | control unit |
| 101 | control lines |

1. A dosing feeder for a powder-fusing apparatus, the dosing feeder comprising:
a powder inlet configured to receive powderfrom a discharge opening of a powder bunker,
a powder outlet configured to release powderto a recoater reservoir of the powder-fusing apparatus,
a powder support being located in between the powder inlet and the powder outlet and configured to convey the powder from the powder inlet to the powder outlet, wherein:
the powder support is coupled to an ultrasonic transmitter and/or to a vibrational drive,
the powder supportcomprises a grate coupled to the ultrasonic transmitter and/or to the vibrational drive, thereby being configured to enable a powder flow through the grate by exiting the grateby operation of the ultrasonic transmitter and/or the vibrational drive.

2. The dosing feederof claim 1, wherein the powder supportcomprises a frame, wherein the grateis supported by the frame.

3. The dosing feeder of claim 1 further comprising a connecting element that connects the grate via the frameto the ultrasonic transmitterand/or to the vibrational drive.

4. The dosing feeder of claim 1, wherein:
the dosing feedercomprises a feeder housing with a powder channel having a channel wall, wherein the powder channel connects the powder inlet and the powder outlet, and
the grate is positioned transverse to a longitudinal extension of the powder channel, thereby separating the powder channel into an inlet facing upper channel portion and an outlet facing lower channel portion.

5. The dosing feeder of claim 4, wherein the channel wall forms a recess, into which the powder support sealingly engages.

6. The dosing feeder of claim 4, wherein the powder supporthas a recess into which a protrusion of the channel wall sealingly engages.

7. The dosing feeder of claim 4, wherein an elastic member is positioned between the powder support and the housing to prevent a direct transmission of vibrations from the powder support to the housing.

8. A powder-bed fusing apparatus, comprising:
at least one dosing feeder according to claim 1,
a process chamber,
a powder bunker with a powder release opening connecting a volume of the bunker with the process chamber, and
a recoater reservoirin the process chamber, wherein:
the powder inlet of the dosing feeder is positioned below the powder release opening of the powder bunker, and
the powder outlet of the dosing feeder dosing feeder’s powder outlet (53) is positioned above the recoater reservoir.

9. The powder bed fusing apparatus of claim 8,
wherein the powder bunker has a powder inlet opening connected to a powder distribution system that is configured to convey powdervia the powder inlet opening of the bunker into the bunker, and
wherein the powder inlet opening of the bunker is protected by a sieve configured to separate particles with a dimension above a predefined dimension, the sieve having a sieve mesh size.

10. The powder-bed fusing apparatus of claim 9, wherein the grate has a grate mesh size that is larger than the sieve mesh size.

11. A method for filling a recoater reservoir of a powder-fusing apparatus that includes a process chamber, a powder bunker, a recoater reservoir, and a dosing feeder (40), wherein the dosing feeder has a powder support, the method comprising the steps of:
(i) Discharging powder from the powder bunkeronto or into a grate of the powder support, and
(ii) Exciting ultrasound at least in the grate of the powder supportof the dosing feeder and/or exciting at least the grate of the powder support to vibrate relative to a process chamber wall to thereby convey powder via an outletof the dosing feeder to the recoater reservoir.

12. The method of claim 11, wherein the powder support being excited is a powder support of the dosing feeder according to claim 1, and/or
wherein the powder support being excited is the powder support of the powder-bed fusion apparatus according to claim 8.

13. The dosing feeder of claim 4, wherein an elastic member is positioned between the powder support and the housing.

14. The dosing feeder of claim 1, wherein the grate has a mesh size that is greater than a size of powder grains for doing of which the dosing feeder is configured.

15. The dosing feeder of claim 14,
wherein the mesh size is smaller than a critical mesh size, and
wherein the critical mesh size is defined such that, when the grate of the dosing feeder is static and has the critical mesh size, the powder placed onto the grate falls through the grate.
